(19) United States
(12) Patent Application Publication
(10) Pub. No.: US 2003/0068030 A1
(43) Pub. Date: Apr. 10, 2003

(54) Automatic dialer

(76) Inventor: Gary Melius, Oyster Bay Cove, NY (US)

Correspondence Address: Philip Braginsky, Scully, Scott, Murphy & Presser, 400 Garden City Plaza, Garden City, NY, 11530, US

(21) Appl. No.: 09/970,542

(22) Filed: Oct. 4, 2001

(51) Int. Cl. H04M 3/42

(52) U.S. Cl. 379/216.01

(57) ABSTRACT

A method and apparatus for composing a telephone dialing string for a telecommunication device that stores pre-programmed strings of characters entered by a key pad by a caller and correlates these strings to an abbreviated key pad sequence. A caller uses a telecommunication device to dial at least one pre-programmed string upon reaching a live telephone line on a telecommunication network by actuation of an abbreviated sequence. The caller then dials a non-programmed string of characters entered by a key pad. This second string may either connect the caller to the called party by completing the calling string or may require another string from another abbreviated sequence. A caller composes the complete dialing string by entering in combination speed dialed, pre-programmed strings and non-programmed strings.

### FIELD OF THE INVENTION

This invention relates to a method and apparatus which provides for automatic dialing of a telecommunication device. More specifically, this method and apparatus provides for entering and dialing pre-programmed character strings by the use of an abbreviated actuation process and further allowing subsequent strings to be entered after the first.

### BACKGROUND OF THE INVENTION

Telephone service is one of the most ubiquitous technologies of our day. With the advent of cellular, satellite, and other mobile telephone options, the entire world is accessible. In most developed countries, it is common to find individuals with land line telephones as well as one or more mobile telephones. The worldwide telephone network is also used by facsimile devices and other communication devices.

This network relies on two premises. One is knowing where the caller is located. The other is knowing the destination of the call. To accomplish the location prerequisites of the telephone network, character strings are used to identify locations. These strings are most often represented by single digits or numbers. The strings are separated into sub-strings that drill down from regional locations to exact locations. Regional strings of exchanges include country codes, city codes and area codes, exact locations are telephone numbers.

Logically, as the telephone networks have grown the character strings have become more complicated; more characters are required to locate more locations. One result of the increasing complexity and ubiquity is that within metropolitan areas, a caller must be familiar with several area codes to locate and contact destination parties.

It is a common requirement in the United States for people to dial 10 digit telephone numbers to make local telephone calls. One finds oneself dialing upwards of eight or more area codes to contact called parties within a thirty mile radius. This requires a caller to dial multiple area codes multiple times when active use of the telephone is required. The inconvenience of this constant dialing is obvious in time, wear and aggravation.

Previous solutions to this inconvenience have relied on automatic dialers that require a caller to program complete character strings as an input to the telephone line. This enables a caller to dial with reduced key strokes, known and pre-programmed strings. If a caller has not pre-programmed the entire string, this method is not available.

There are additional solutions that rely on directories for identifying corresponding area codes with entered telephone numbers. These systems also use automatic dialers to enter the complete character string onto the telephone line for correction.

All of the previous solutions require pre-programming telephone numbers with exchanges. The complete strings are located and automatically dialed. What these solutions all lack is a method and system for inputting one or more pre-programmed sequences by abbreviated methods and then adding additional digits or sequences that are not pre-programmed.

### SUMMARY OF THE INVENTION

The present invention comprises a method for composing a telephone dialing string for a telecommunication device. The method provides for storing a first string of characters entered by a key pad by a caller, correlating the first string to an abbreviated key pad sequence, dialing the first string upon reaching a live telephone line by actuating the abbreviated sequence, and finally dialing a second string of characters entered by a key pad for connecting the caller to a called party. The invention uses known programming and auto-dialing methods.

This method allows a caller to compose complete dialing strings by mixing and matching programmed strings with non-programmed strings. For example, a caller may initiate a long distance call by first actuating a single key that is programmed for a billing code. The caller next actuates a second key that is programmed for a commonly dialed area code. Lastly, the caller enters a seven digit telephone number that completes the call and enters the complete string onto the line and network.

The invention can be of numerous embodiments including a device that composes telephone numbers for the telecommunication device by abbreviated key actuation and speed dialing. The device includes a storage module for storing pre-programmed digit sequences and related abbreviated sequences; a processor module for implementing the programming of the digit sequences and abbreviation operations; a known line in/out connector for connecting to a telephone network; a known keypad for entering the digit sequences for programming, abbreviated dialing, and dialing; and, any type of telecommunication device.

### BRIEF DESCRIPTION OF DRAWINGS

FIG. 1 is a perspective view of one embodiment of the telephone dialer.

FIG. 2 is a block diagram of the control unit.

FIG. 3 is a block diagram of the telephone dialer.

FIG. 4 is a logic diagram of the telephone dialer.

### DETAILED DESCRIPTION OF THE INVENTION

This invention provides for a method of automatically dialing a telephone number prefix while allowing for additional telephone number strings to be added to the prefix and an apparatus to accomplish the same. The invention can take the form of several different embodiments, some of which are included as a detailed description of the invention.

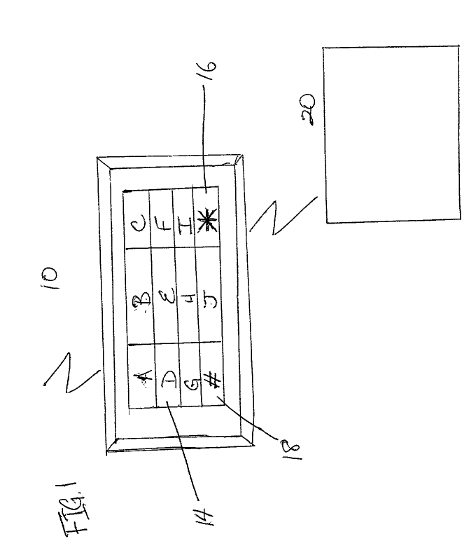

FIG. 1 is one embodiment of the invention as stand-alone apparatus, a control unit 10, that is used to program, store and dial the prefix strings. This apparatus is a separate module linked to an existing telephone network and hardware. Once the pre-programmed prefix string is dialed by actuating a key 14, a caller returns to the telephone or other telecommunication device 20 to enter the remaining characters to complete the telephone number. This apparatus is logically placed before the telephone and the line connection to the network. Physically, it might be placed between the telephone and the wall. This apparatus consists of storage, a processor, and a line in/out connector.

The control unit 10 is programmed by known methods using the keypad of the telecommunication device and the control unit. A start or enter or end signal may be processed using the asterisk 16 and/or pound key 18 when necessary.

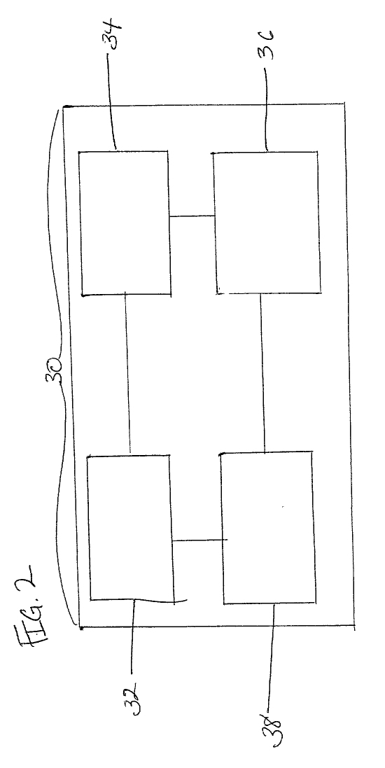

FIG. 2 depicts, in block form, the control unit. The control unit 30 has a dialing memory 32 which is a random access memory (RAM). The dialing memory 32 is used to store the programmed sequences of digits and their relative abbreviated dialing sequence. A program memory 34 is a read-only memory (ROM). The program memory 34 stores the programming code and logic for entering, storing and retrieving the programmed sequences. The program memory 34 contains the relational decoding information between the sequences and abbreviated sequences. A programming circuit 36 is used to correlate the actuation of the keys with the programming memory. A dialing circuit 38 is used to correlate the actuation of dialing to the dialing memory.

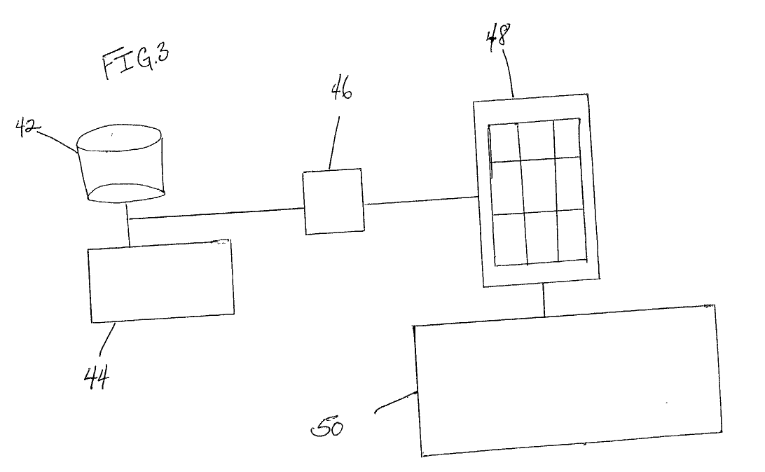

FIG. 3 depicts a general embodiment of the present invention. This format can be incorporated within any telecommunication device or as a stand-alone device as in FIG. 1. The essential elements of the invention are a storage module 42, a processor module 44, a line in/out connector 46, a keypad 48, and a telecommunication device 50. The storage module 42 stores the programmed sequences and their related abbreviated sequences. The processor 44 implements the programming and abbreviation operations. The telecommunication device 50 provides for the operations of such a device as is known in the art. The key pad 48 provides for entering the sequences of digits for programming, abbreviated dialing, and dialing. The line connector 46 enables the telecommunication device to enter and exit a telecommunication network.

The elements of FIG. 3 can be manifested within one device, as separate elements or combined in any format to provide for the proper operation of the invention.

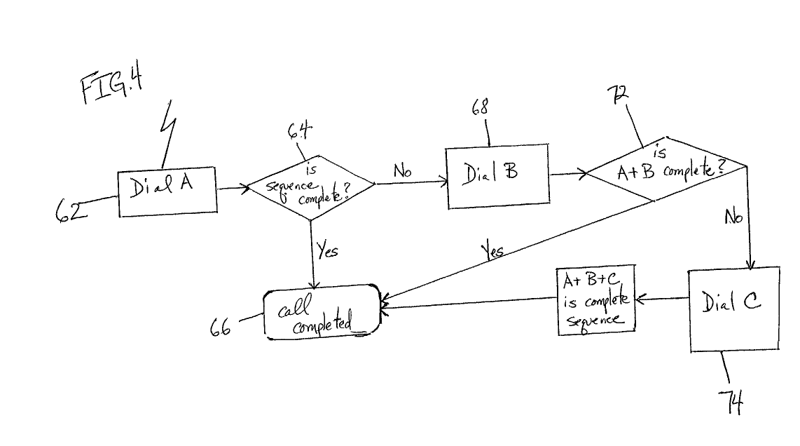

FIG. 4 is a logical diagram of the present invention. The method begins by registering an open line when a caller opens a line. Once a line is open a sequence is dialed by the caller 62. It is then determined whether this sequence is a complete sequence. If it is a complete sequence the sequence is entered onto the line and a call is completed 66. If the sequence is not complete, a second sequence is entered by the caller 68. The initial sequence and second sequence are checked to determine if they compose a complete sequence 72. If a complete sequence is composed, it is entered onto the line and the call is completed 66. If the sequence is not complete, another sequence may be entered 74. This process carries on until a complete sequence is entered and a call completed or the line is closed.

In FIG. 4, each of the sequence of digits may be pre-programmed into a storage unit and designated by an abbreviated sequence. This may be done by known speed dialing methods. Therefore, a complete call may be composed by a combination of speed dialing keys and single digit keys. These keys maybe mixed and matched as required.

It is particularly convenient for large metropolitan areas to pre-program area codes as speed dial keys. Then a caller need only actuate one key to dial an area code (an initial sequence), and next enter the remaining digits of the complete sequence to reach the called party. Besides area codes, billing codes and country codes are also convenient to store.

Accordingly, it should be readily appreciated that the automatic dialer of the present invention has many practical applications. Additionally, although the preferred embodiment has been illustrated and described, it will be obvious to those skilled in the art that various modifications can be made without departing from the spirit and scope of this invention. Such modifications are to be considered as included in the following claims unless the claims expressly recite differently.

What is claimed is:

1. A method for composing a dialing string for a telecommunication device comprising:
storing at least one string of characters entered by a caller onto a key pad;
correlating each stored string to an abbreviated key pad sequence;
dialing at least one string upon reaching a live telephone line by initiating the abbreviated sequence correlated to each string; and,
dialing a non-stored string of characters entered on a key pad for connecting the caller to a called party.

2. A method for composing a telephone dialing string as in claim 1 wherein:
an area code is stored as a string of characters.

3. A method for composing a telephone dialing string as in claim 1 wherein:
a country code is stored as a string of characters.

4. A method for composing a telephone dialing string as in claim 1 wherein:
a billing code is stored as a string of characters.

5. A method for connecting a calling party to a called party using a telecommunication device comprising:
receiving at least one sequence of digits from a pre-programmed abbreviated key sequence initiated by the calling party;
receiving a non-programmed sequence of digits from the calling party entering the digits by a key pad; and,
initiating a call by transferring the pre-programmed and non-programmed sequences to a telephone network at a live dial tone.

6. A method for abbreviating a telephone calling sequence comprising:
dialing at least one sequence by actuation of pre-programmed speed dialed keys; and,
dialing a further sequence by actuation of keys that complete the dialing sequence and connect a live telephone line to a called party through a telephone network.

7. A device for abbreviating a telephone calling sequence comprising:
a programming circuit with a central processing unit for pre-programming at least one sequence of digits to be dialed by a telecommunication device;
a memory for storing the pre-programmed sequences;
means for outputting the pre-programmed sequences to the telecommunication device upon actuation of an abbreviated sequence of keys whereupon the device provides for entering further sequences of digits after the initial sequence is entered.

8. A device for composing telephone numbers for a telecommunication device by abbreviated key actuation comprising:
a storage module for storing pre-programmed digit sequences and related abbreviated speed dial sequences;
a processor module for implementing programming digit sequences and speed dial operations;
a line in/out connector for connecting to a telephone network;
a keypad for entering the digit sequences for programming, abbreviated dialing, and dialing; and
a telecommunication device for communication with a called party upon actuation of pre-programmed sequences and non-programmed sequences to complete a call over a telecommunication network.
